(19) United States
(12) Patent Application Publication
(10) Pub. No.: US 2024/0007260 A1
(43) Pub. Date: Jan. 4, 2024

(54) DYNAMIC RECONFIGURATION ASSOCIATED WITH TRANSMITTING SOUNDING REFERENCE SIGNAL (SRS) INFORMATION

(71) Applicant: QUALCOMM Incorporated, San Diego, CA (US)

(72) Inventors: Runxin WANG, San Diego, CA (US); Muhammad Sayed Khairy ABDELGHAFFAR, San Jose, CA (US); Yu ZHANG, San Diego, CA (US)

(21) Appl. No.: 18/251,830

(22) PCT Filed: Dec. 22, 2020
(86) PCT No.: PCT/CN2020/138233

§ 371 Date: May 4, 2023

(51) Int. Cl. H04L 5/00; H04W 72/23

(52) U.S. Cl. CPC H04L 5/0094; H04W 72/23; H04L 5/0048

(57) ABSTRACT

Various aspects of the present disclosure generally relate to wireless communication. In some aspects, a user equipment (UE) may receive configuration information including a sounding reference signal (SRS) configuration associated with configured SRS resources. The UE may receive a medium access control (MAC) control element (MAC CE) or downlink control information (DCI) including reconfiguration information associated with the SRS resources. The UE may transmit, based at least in part on the reconfiguration information, SRS information including select SRS resources, selected from among the configured SRS resources, utilizing select SRS ports. Numerous other aspects are described.

### FIELD OF THE DISCLOSURE

Aspects of the present disclosure generally relate to wireless communication and to techniques and apparatuses for dynamic reconfiguration associated with transmitting sounding reference signal (SRS) information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a user equipment (UE) for wireless communication includes a memory and one or more processors operatively coupled to the memory, the memory and the one or more processors configured to: receive configuration information including a sounding reference signal (SRS) configuration associated with configured SRS resources; receive a medium access control (MAC) control element (MAC CE) or downlink control information (DCI) including reconfiguration information associated with the SRS resources; and transmit, based at least in part on the reconfiguration information, SRS information including select SRS resources, selected from among the configured SRS resources, utilizing select SRS ports.

In some aspects, a method of wireless communication performed by a UE includes receiving configuration information including an SRS configuration associated with configured SRS resources; receiving a MAC CE or DCI including reconfiguration information associated with the SRS resources; and transmitting, based at least in part on the reconfiguration information, SRS information including select SRS resources, selected from among the configured SRS resources, utilizing select SRS ports.

In some aspects, a non-transitory computer-readable medium storing a set of instructions for wireless communication includes one or more instructions that, when executed by one or more processors of a UE, cause the UE to: receive configuration information including an SRS configuration associated with configured SRS resources; receive a MAC CE or DCI including reconfiguration information associated with the SRS resources; and transmit, based at least in part on the reconfiguration information, SRS information including select SRS resources, selected from among the configured SRS resources, utilizing select SRS ports.

In some aspects, an apparatus for wireless communication includes means for receiving configuration information including an SRS configuration associated with configured SRS resources; means for receiving a MAC CE or DCI including reconfiguration information associated with the SRS resources; and means for transmitting, based at least in part on the reconfiguration information, SRS information including select SRS resources, selected from among the configured SRS resources, utilizing select SRS ports.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example associated with dynamic reconfiguration associated with transmitting SRS information, in accordance with various aspects of the present disclosure.

FIG. 4 is a diagram illustrating an example associated with dynamic reconfiguration associated with transmitting SRS information, in accordance with various aspects of the present disclosure.

FIG. 5 is a diagram illustrating an example associated with dynamic reconfiguration associated with transmitting SRS information, in accordance with various aspects of the present disclosure.

FIG. 6 is a diagram illustrating an example process associated with dynamic reconfiguration associated with transmitting SRS information, in accordance with various aspects of the present disclosure.

FIG. 7 is a diagram illustrating an example apparatus associated with dynamic reconfiguration associated with transmitting SRS information, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

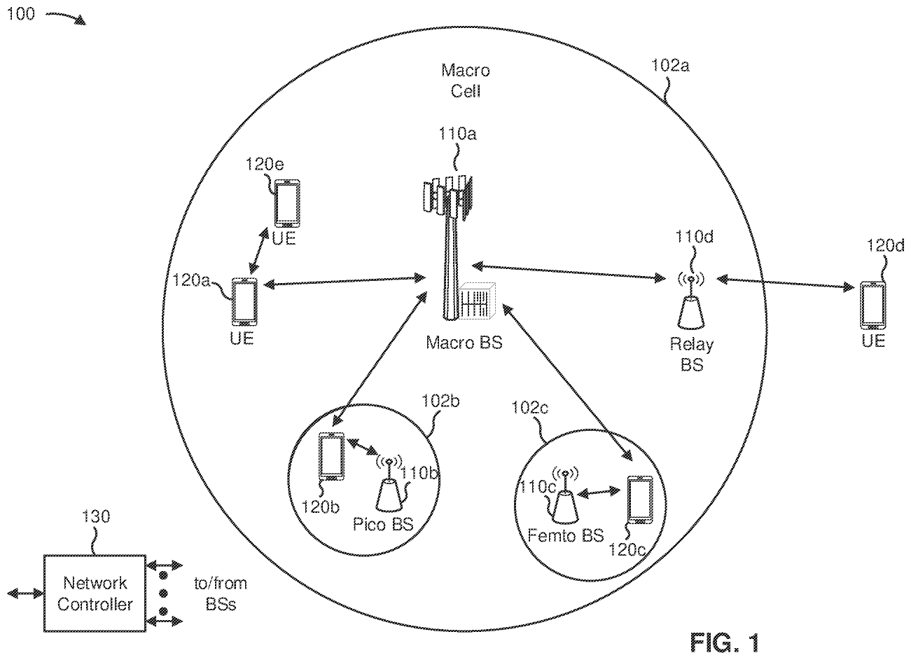

FIG. 1 is a diagram illustrating an example of a wireless network 100, in accordance with various aspects of the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, directly or indirectly, via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol or a vehicle-to-infrastructure (V2I) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

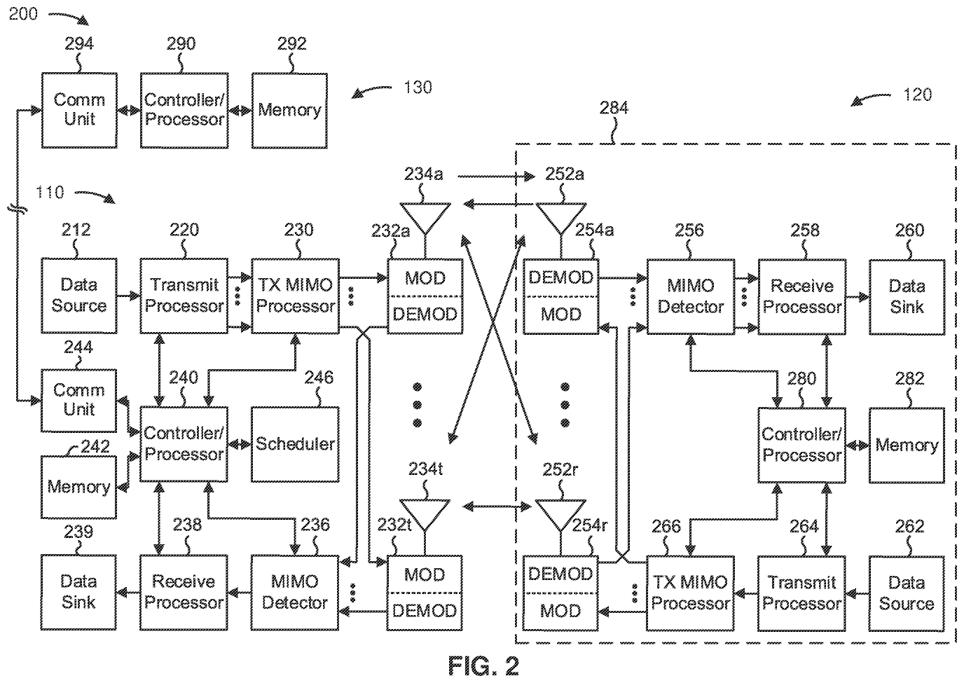

FIG. 2 is a diagram illustrating an example 200 of abase station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a channel quality indicator (CQI) parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

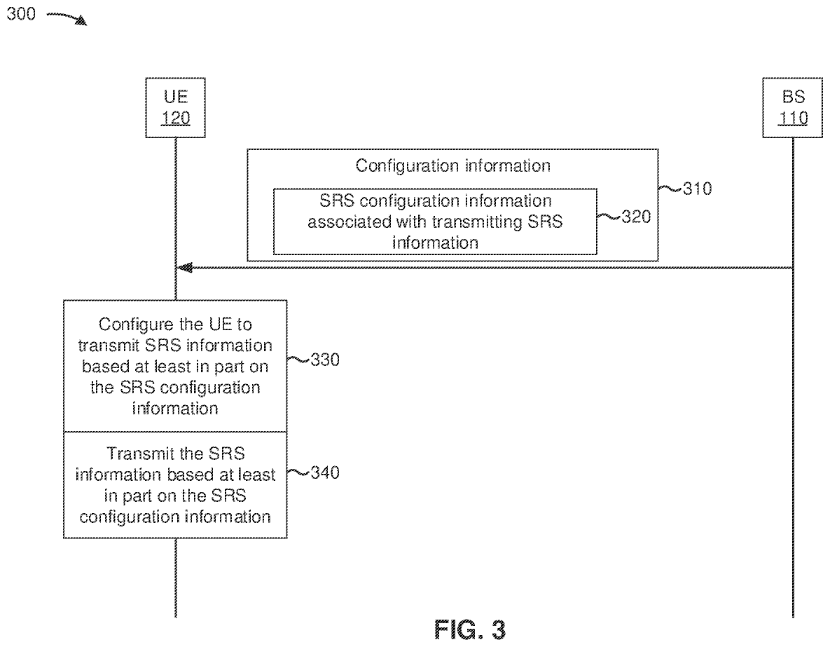

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-7.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-7.

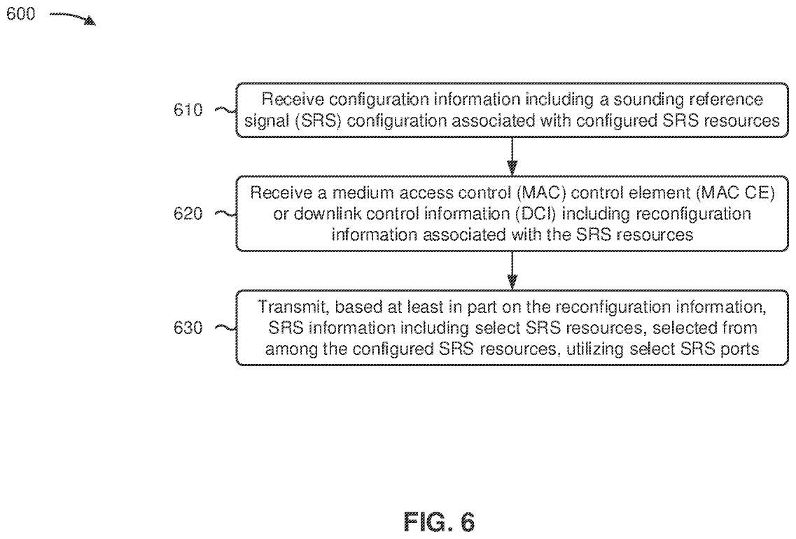

Controller/processor 240 of base station 110, controller/processor 280 of UE 120, and/or any other component(s) of FIG. 2 may perform one or more techniques associated with dynamic reconfiguration associated with transmitting sounding reference signal (SRS) information, as described in more detail elsewhere herein. For example, controller/processor 240 of base station 110, controller/processor 280 of UE 120, and/or any other component(s) of FIG. 2 may perform or direct operations of, for example, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 600 of FIG. 6, and/or other processes as described herein. In some aspects, executing instructions may include running the instructions, converting the instructions, compiling the instructions, and/or interpreting the instructions, among other examples.

In some aspects, a UE (e.g., UE 120) includes means for receiving configuration information including an SRS configuration associated with configured SRS resources; means for receiving a MAC CE or DCI including reconfiguration information associated with the SRS resources; and/or means for transmitting, based at least in part on the reconfiguration information, SRS information including select SRS resources, selected from among the configured SRS resources, utilizing select SRS ports. The means for the UE to perform operations described herein may include, for example, one or more of antenna 252, demodulator 254, MIMO detector 256, receive processor 258, transmit processor 264, TX MIMO processor 266, modulator 254, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A UE may conduct data communication with a BS in a wireless network such as an LTE network or a 5G/NR network. The BS and UE may utilize respective transmission and reception circuitry to conduct the data communication. The data communication may include downlink communications from the BS to the UE and may include uplink communications from the UE to the BS.

To adequately receive the uplink communications from the UE, the BS may estimate a measure of quality associated with the uplink communications. To enable the BS to estimate the measure of quality, the UE may utilize a configuration of SRS ports to transmit SRS information that includes a fixed number of SRS resources. Based on receiving the SRS information, the BS may estimate the measure of quality associated with the uplink communications. The SRS resources may be configured by the BS to enable the UE to perform, for example, antenna switching operations, codebook-based operations, non-codebook-based operations, beam management operations, or the like.

The configuration of the SRS ports, utilized by the UE to transmit the SRS information, may be fixed during initiation of the data communication between the BS and the UE based on channel conditions existing during the initiation of the data communication. However, because channel conditions may vary based on, for example, movement of the UE within an environment, a fixed configuration of the SRS ports may not be optimal for transmission of the SRS information during the data communication.

For instance, during the data communication, a channel associated with a port related to the fixed configuration may experience poor channel conditions (e.g., a measure of quality associated with channel conditions is less than a threshold channel condition level), and when the UE transmits the SRS information utilizing the port, the BS may not adequately receive the SRS information. As a result, the BS may not be able to adequately estimate the measure of quality associated with the uplink communications and, therefore, may not be able to adequately receive uplink communications from the UE. Consequently, the data communication between the UE and the BS may experience an interruption or a stoppage.

With respect to the fixed number of SRS resources, the UE may have to transmit all configured SRS resources even when it may be sufficient for the BS to receive a subset of the configured SRS resources to estimate the measure of quality associated with the uplink communications. Transmitting all configured SRS resources may inefficiently consume UE resources (e.g., amount of processing, utilization of memory, power consumption, or the like) and network resources (e.g., bandwidth, management resources, or the like) that could be more efficiently utilized to perform other tasks related to the data communication.

Various aspects of techniques and apparatuses described herein may enable dynamic reconfiguration associated with transmitting SRS information. In some aspects, during initiation of a data communication between a BS and a UE, the UE may receive an initial configuration to utilize one or more SRS ports to transmit SRS information including one or more SRS resources. During the data communication, the UE may receive dynamic signaling (e.g., medium access control (MAC) signaling including a control element (MAC CE), downlink control information (DCI) signaling, or a combination thereof) to dynamically reconfigure the UE to utilize select SRS ports to transmit the SRS information including select SRS resources. The dynamic reconfiguration may be based on channel conditions existing during the data communication. As a result, the UE may utilize select (e.g., optimal) SRS ports to transmit the SRS information including select SRS resources sufficient to enable the BS to estimate a measure of quality associated with uplink communications. In this way, the BS may adequately receive the uplink communications from the UE, and the data communication between the UE and the BS may continue uninterrupted. Additionally, utilization of the select SRS ports to transmit the SRS information including the select SRS resources may enable efficient utilization of UE resources (e.g., amount of processing, utilization of memory, or the like) and network resources (e.g., bandwidth, subchannels, or the like). In this way, data communication between the UE and the BS may be improved.

In some aspects, a UE may receive configuration information including an SRS configuration associated with SRS resources; receive a MAC CE or DCI including reconfiguration information associated with the SRS resources; and transmit SRS information including select SRS resources, from among the SRS resources, utilizing select SRS ports based at least in part on the reconfiguration information. As used herein, “transmitting an SRS resource” is synonymous with “transmitting an SRS on an SRS resource.”

FIGS. 3-5 are diagrams illustrating examples 300, 400, and 500 associated with dynamic reconfiguration associated with transmitting SRS information, in accordance with various aspects of the present disclosure. FIG. 3 shows a UE 120 and a BS 110 conducting data communication in, for example, an LTE network or a 5G/NR network. The data communication may include downlink communications from the BS 110 to the UE 120 and may include uplink communications from the UE 120 to the BS 110.

As shown by reference number 310, the BS 110 may transmit, and the UE 120 may receive, configuration information at a beginning (e.g., during initiation) of the data communication. In some aspects, the UE 120 may receive the configuration information from a device other than BS 110 (e.g., from another base station). In some aspects, the UE 120 may receive the configuration information via, for example, a control channel (e.g., a physical downlink control channel (PDCCH)) between the UE 120 and the BS 110. The configuration information may be communicated via radio resource control (RRC) signaling, MAC signaling (e.g., MAC CE), DCI signaling, or a combination thereof (e.g., RRC configuration of a set of values for a parameter and DCI indication of a selected value of the parameter).

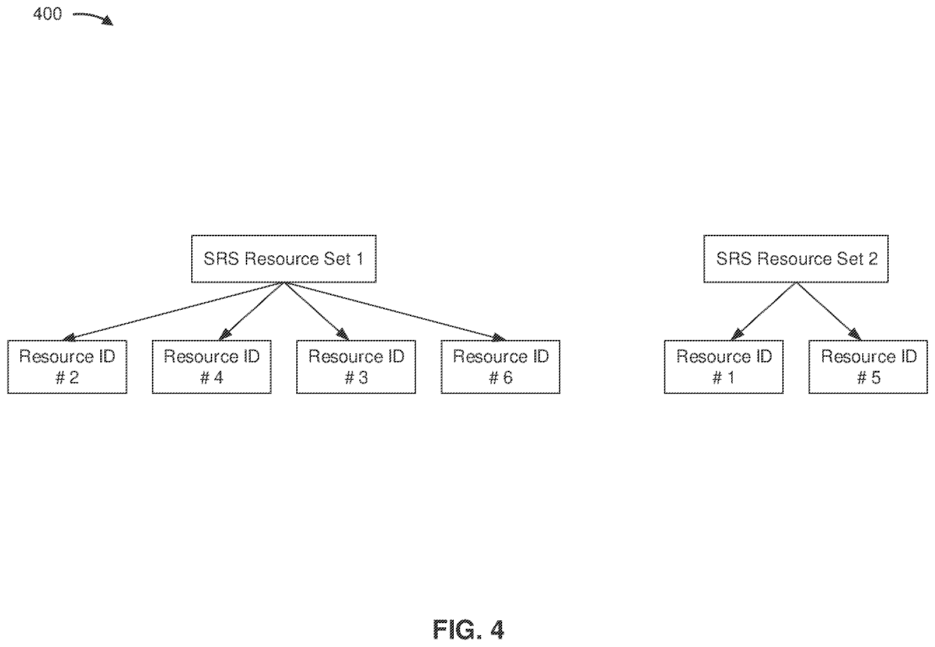

In some aspects, the configuration information may include information associated with configuring the UE 120 with one or more SRS resource sets, each SRS resource set comprising a respective one or more SRS resources (e.g., the configured SRS resources). The configured SRS resources may be utilized by the UE 120 to perform, for example, SRS signaling antenna switching operations, codebook-based operations, non-codebook-based operations, beam management operations, or the like. For instance, as shown in example 400 of FIG. 4, the UE 120 may be configured with two resource sets (e.g., SRS Resource Set 1 and SRS Resource Set 2) including the configured SRS resources. SRS Resource Set 1 may include, for example, four SRS resources having respective resource IDs Resource ID #2, Resource ID #3, Resource ID #4, and Resource ID #6. SRS Resource Set 2 may include, for example, two SRS resources having respective resource IDs Resource ID #1 and Resource ID #5. In some aspects, SRS Resource Set 1 and SRS Resource Set 2 that include all the configured SRS resources may collectively be referred to as a superset. As discussed herein, “an SRS resource having Resource ID #2” is synonymous with “Resource ID #2.”

In some aspects, the configuration information may include an indication of, for example, one or more configuration parameters for the UE 120 to use to configure the UE 120 for the data communication. The configuration information may include an initial configuration associated with transmitting SRS information. The initial configuration may indicate that the UE 120 is to utilize one or more fixed SRS ports to transmit SRS information including all the configured SRS resources.

With respect to the SRS resources, the initial configuration may include one or more predefined orders of the configured SRS resources to be included in the SRS information. The one or more predefined orders of the configured SRS resources may be defined in terms of resource identifiers and may be included in a resource identifier list (e.g., srs-ResourceIdList).

In an example, the predefined order may include the resource identifiers in a low to high order. For instance, with respect to example 400 of FIG. 4, the low to high older may indicate that the configured SRS resources are to be ordered as Resource ID #1, Resource ID #2, Resource ID #3, Resource ID #4, Resource ID #5, and Resource ID #6 in the SRS information. In another example, the predefined order may include resource identifiers in an order of arrangement within an SRS Resource Set. For instance, the order of arrangement may indicate that the SRS resources from SRS Resource Set 1 are to be ordered as Resource ID #2, Resource ID #4, Resource ID #3, and Resource ID #6 in the SRS information. Similarly, the order of arrangement may indicate that the SRS resources from SRS Resource Set 2 are to be ordered as Resource ID #1 and Resource ID #5 in the SRS information.

In yet another example, the predefined order may include a staggered order or an interlaced order. In the staggered order, the configured SRS resources may be included in the SRS information according to SRS Resource Sets. For instance, the staggered order may indicate that the SRS resources from SRS Resource Set 1 are to be included before the SRS resources from SRS Resource Set 2, or vice versa. In the interlaced order, the SRS resources from the SRS Resource Sets may be interlaced such that the SRS resources from the SRS Resource Sets are alternately included in the SRS information. With respect to example 400 of FIG. 4, the interlaced order may indicate that the SRS resources are to be ordered as, for example, Resource ID #2, Resource ID #1, Resource ID #4, Resource ID #5, Resource ID #3, and Resource ID #6. Alternatively, the interlaced order may indicate that the SRS resources are to be ordered as, for example, Resource ID #1, Resource ID #2, Resource ID #5, Resource ID #4, Resource ID #3, and Resource ID #6. In some aspects, the predefined order may include any combination of the low to high order, the order of arrangement, the staggered order, and/or the interlaced order.

As shown by reference number 320, the configuration information may include SRS configuration information associated with transmitting SRS information. As shown by reference number 330, based at least in part on the SRS configuration information, the UE 120 may configure the UE 120 to transmit the SRS information.

In some aspects, the SRS configuration information may enable the UE 120 to configure the UE 120 to utilize the select SRS ports to transmit the SRS information including the select SRS resources based at least in part on included reconfiguration information. The reconfiguration information may be received via dynamic signaling from the BS 110 during the data communication. The dynamic signaling may include the MAC CE, the DCI, or a combination thereof and may include reconfiguration information associated with the select SRS ports and/or the select SRS resources.

With respect to the SRS resources, the reconfiguration information may explicitly indicate one or more SRS resource identifiers of one or more select SRS resources that are to be included in the SRS information. Based at least in part on receiving the reconfiguration information, the UE 120 may transmit the SRS information including the one or more select SRS resources.

In some aspects, the reconfiguration information may indicate a quantity (e.g., a number) of the select SRS resources to be included in the SRS information. In some aspects, the quantity of the select SRS resources may be less than the total number of configured SRS resources. In some aspects, the quantity of the select SRS resources may be sufficient for the BS 110 to estimate a measure of quality associated with uplink communications from the UE 120 to the BS 110. The quantity may include a quantity of select SRS resources from one or more of the SRS Resource Sets. In some aspects, the reconfiguration information may identify the one or more resource sets via a resource set identifier (e.g., SRS Resource Set 1, SRS Resource Set 2, or the like). In a situation where the reconfiguration information does not identify a resource set identifier, the UE 120 may include the quantity of SRS resources from among all of the configured SRS resources.

In an example, the reconfiguration information may indicate that, for example, one SRS resource from SRS Resource Set 1 is to be included in the SRS information. Based at least in part on receiving the reconfiguration information, the UE 120 may transmit the SRS information including, for example, Resource ID #2. In another example, the reconfiguration information may indicate that, for example, two SRS resources from each of SRS Resource Set 1 and SRS Resource Set 2 are to be included in the SRS information. Based at least in part on receiving the reconfiguration information, the UE 120 may transmit the SRS information including, for example, Resource ID #3 and Resource ID #6 from SRS Resource Set 1 and Resource ID #1 and Resource ID #5 from SRS Resource Set 2.

In some aspects, the reconfiguration information may update the predefined order included in the initial configuration. For instance, the reconfiguration information may update the low to high order, the order of arrangement, the staggered order, and/or the interlaced order included in the initial configuration. In an example, the reconfiguration information may indicate that the select SRS resources are to be ordered in a high to low order instead of the predefined low to high order. In this case, the UE 120 may transmit the SRS information including the select SRS resources ordered as, for example, Resource ID #6, Resource ID #5, Resource ID #4, Resource ID #3, Resource ID #2, and Resource ID #1.

In another example, the reconfiguration information may update the staggered order to indicate that the select SRS resources from SRS Resource Set 2 are to be included before the select SRS resources from SRS Resource Set 1. Further, the configuration information may indicate that three select SRS resources are to be included in the SRS information. In this case, the UE 120 may transmit the SRS information including the select SRS resources ordered as, for example, Resource ID #1, Resource ID #5, and Resource ID #2. Similarly, the reconfiguration information may update the order of arrangement and/or the interlaced order included in the predefined order.

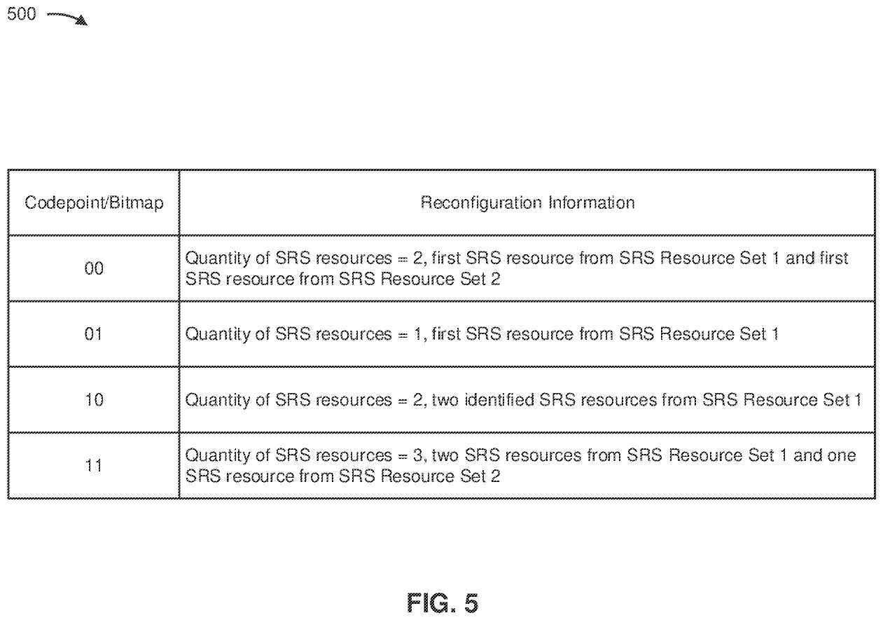

In some aspects, the reconfiguration information may include a bitmap and/or a codepoint including one or more bit fields to indicate a combination of a quantity of the select SRS resources and at least one of information identifying an SRS resource or an ordered list of the SRS resource identifiers. For instance, as shown in example 500 of FIG. 5, the bitmap and/or codepoint may indicate that two select SRS resources, the first SRS resource from SRS Resource Set 1 and the first SRS resource from SRS Resource Set 2, are to be included in the SRS information (codepoint/bitmap 00). Based at least in part on receiving the reconfiguration information, the UE 120 may transmit the SRS information including, for example, Resource ID #2 and Resource ID #1. The bitmap and/or codepoint may indicate that one select SRS resource, the first SRS resource from SRS Resource Set 1, is to be included in the SRS information (codepoint/bitmap 01). Based at least in part on receiving the reconfiguration information, the UE 120 may transmit the SRS information including, for example, Resource ID #2. The bitmap and/or codepoint may indicate that two select SRS resources, as identified via SRS resource identifiers, from SRS Resource Set 1 are to be included in the SRS information (codepoint/bitmap 10). For instance, the reconfiguration information may identify Resource ID #4 and Resource ID #3 as the two select SRS resources that are to be included in the SRS information. The bitmap and/or codepoint may indicate that three select SRS resources, two SRS resources from SRS Resource Set 1 and one SRS resource from SRS Resource Set 2, are to be included in the SRS information (codepoint/bitmap 11). Based at least in part on receiving the reconfiguration information, the UE 120 may transmit the SRS information including, for example, Resource ID #3 and Resource ID #6 from SRS Resource Set 1 and Resource ID #5 from SRS Resource Set 2.

In some aspects, the DCI may indicate triggered SRS Resource Sets (e.g., SRS Resource Sets for which the UE 120 is to transmit SRS information) and indicate the quantity of select SRS resources to be included. When the select SRS resources are associated with antenna switching and are from a plurality of SRS Resource Sets, the quantity indicated by the DCI may indicate a total number of select SRS resources from the plurality of SRS Resource Sets. For instance, with respect to example 400 of FIG. 4, when the DCI indicates that SRS Resource Set 1 and SRS Resource Set 2 are triggered and indicates the quantity of select SRS resources as two, then, for example, the first SRS resource (e.g., Resource ID #2) from SRS Resource Set 1 and the first SRS resource (e.g., Resource ID #1) from SRS Resource Set 2 may be included in the SRS information. In some aspects, the reconfiguration information can be different based at least in part on a usage and time behavior (e.g., antenna switching operations, codebook operations, non-codebook operations, or the like) associated with the select SRS resources.

In some aspects, the MAC CE may deactivate one or more SRS resources from among the superset including the configured SRS resources, and the DCI may dynamically indicate a quantity of the select SRS resources from among a remainder of the SRS resources not deactivated by the MAC CE. For instance, the MAC CE may deactivate, for example, Resource ID #2 and Resource ID #5. The DCI may dynamically indicate that a quantity (e.g., one, two, three, or four) of select SRS resources from among Resource ID #4, Resource ID #3, Resource ID #6, and Resource ID #1 are to be included in the SRS information.

In some aspects, the DCI may include an SRS request indicator (SRI) to indicate a quantity of the select SRS resources. In some aspects, a bit field included in the SRI may indicate the quantity of the select SRS resources. The bit field may include an existing SRI bit field included in, for example, DCI format 0_1 and/or 0_2 transmitted without data. In some aspects, the DCI may be revised to repurpose a bit field to indicate the quantity of the select SRS resources. In some aspects, such a repurposed bit field may also indicate an SRS resource identifier of a select SRS resource to be included in the SRS information. The repurposed bit field may include a bit field associated with scheduling of resources (e.g., modulation and coding scheme (MCS) scheduling, time domain resource assignment (TDRA), frequency domain resource assignment (FDRA), or the like) transmitted in a non-scheduling DCI format.

With respect to select ports, the reconfiguration information (e.g., MAC CE and/or DCI) may indicate one or more select SRS ports to be utilized by the UE 120 for transmitting the SRS information. In some aspects, the reconfiguration information may indicate a quantity of select SRS ports to be utilized for transmitting select SRS resources from a given SRS Resource Set. For instance, the reconfiguration information may indicate a first quantity of select SRS ports to be utilized for transmitting select SRS resources from SRS Resource Set 1 and a second quantity of select SRS ports to be utilized for transmitting select SRS resources from SRS Resource Set 2. In some aspects, the first quantity may be different from the second quantity. In some aspects, the reconfiguration information may indicate a quantity of select SRS ports to be utilized for transmitting select SRS resources from all triggered SRS Resource Sets. For instance, the reconfiguration information may indicate a first quantity of select SRS ports to be utilized for transmitting select SRS resources from triggered SRS Resource Set 1 and a second quantity of select SRS ports to be utilized for transmitting select SRS resources from triggered SRS Resource Set 2. Based at least in part on receiving the reconfiguration information, the UE 120 may utilize the first quantity of select SRS ports to transmit the SRS information when SRS Resource Set 1 is triggered and may utilize the second quantity of select SRS ports to transmit the SRS information when SRS Resource Set 2 is triggered. In some aspects, SRS Resource Set 1 and SRS Resource Set 2 may be triggered at a same time. In some aspects, the first quantity may be the same as the second quantity. In some aspects, all triggered SRS Resource Sets may be associated with antenna switching operations.

In some aspects, when the MAC CE deactivates one or more select SRS resources, as discussed previously, the DCI may indicate the quantity of SRS ports to be utilized for transmitting a remainder of the select SRS resources that are not deactivated by the MAC CE.

In some aspects, the configuration information may enable the UE 120 to configure the UE 120 to transmit the SRS information based at least in part on a time of receipt of the reconfiguration information (e.g., MAC CE and/or DCI). For instance, the UE 120 may transmit the SRS information, based at least in part on the reconfiguration information included in a MAC CE, after a MAC CE duration of time. In some aspects, the MAC CE duration of time may include 3 milliseconds and a delta duration of time (e.g., a duration associated with a given number of delta time symbols) after receiving the MAC CE. Similarly, the UE 120 may transmit the SRS information, based at least in part on the reconfiguration information included in DCI, after a DCI duration of time. In some aspects, the DCI duration of time may include a processing time duration (e.g., a duration of time associated with processing information included in the DCI and transmitting the SRS information) and the delta duration of time after receiving the DCI. In some aspects, the given number of delta time symbols may be associated with a subcarrier spacing utilized for transmitting the MAC CE and/or DCI. In some aspects, the given number of delta time symbols may be different based at least in part on a usage and/or time behavior (e.g., antenna switching operations, codebook operations, non-codebook operations, or the like) associated with the select SRS resources.

In some aspects, the select SRS resources and/or the select SRS ports may be associated with a given transmission-reception point (TRP) when the UE 120 is in communication with a plurality of TRPs associated with the BS 110. In some aspects, the select SRS resources and/or the select SRS ports may be associated with one or more sets of codebook and/or non-codebook operations. In some aspects, a given TRP may deactivate one or more select SRS resources via the MAC CE and/or DCI. If the given TRP utilizes the DC for deactivation, such deactivation may be indicated via the SRI field included in the DCI.

In some aspects, the UE 120 may exercise power control to determine an amount of transmission power to be used for transmitting the SRS information while utilizing a given select SRS port. In some aspects, the UE 120 may determine a scaling factor to determine the amount of transmission power. For instance, in some aspects, the UE 120 may divide a total amount of power associated with transmitting the SRS information among the indicated quantity of the select SRS ports. In some aspects, the configuration information may configure, and the reconfiguration information may reconfigure, a transmission power for a given SRS Resource Set. For instance, the configuration information may configure, and the reconfiguration information may reconfigure, a first transmission power for transmitting the SRS information including select SRS resources from SRS Resource Set 1 and a second transmission power for transmitting the SRS information including select SRS resources from SRS Resource Set 2.

In some aspects, a current transmission of the SRS information may include SRS resources based at least in part on the reconfiguration information. The current transmission may be associated with, for example, the next transmission of the SRS information currently being determined by the UE 120. In some aspects, the current transmission may include select SRS resources from SRS Resource Sets triggered by reconfiguration information received via the DCI. In some aspects, a future transmission of the SRS information may include select SRS resources from SRS Resource Sets triggered by reconfiguration information received via the MAC CE. The future transmission may be a transmission of the SRS information after transmission of the current transmission of the SRS information.

Alternatively, the UE 120 may transmit the current transmission and future transmissions based at least in part on the last received reconfiguration information until the UE 120 receives new reconfiguration information. In this case, the current and future transmissions may include select SRS resources from SRS Resource Sets triggered by the last received reconfiguration information received via the MAC CE until new reconfiguration information and/or deactivation information for deactivating one or more select SRS resources is received via another MAC CE and/or DCI. Similarly, the current and future transmissions may include select SRS resources from SRS Resource Sets triggered by the last received reconfiguration information received via DCI until new reconfiguration information is received via another MAC CE and/or DCI.

In some aspects, the UE 120 may transmit the current transmission and/or the future transmission based at least in part on previous reconfiguration information used to transmit a previous transmission of the SRS information. Alternatively, the UE 120 may transmit the current transmission and/or the future transmission based at least in part on a default configuration predetermined by the BS 110 and provided to the UE 120 via, for example, the configuration information.

As shown by reference number 340, the UE 120 may transmit the SRS information based at least in part on receiving the configuration information and/or the SRS configuration information, as discussed above. In some aspects, the UE 120 may utilize included transmission circuitry to transmit the SRS information and may utilize included reception circuitry to receive the configuration information and/or the SRS configuration information. The transmission circuitry may include, for example, one or more components (e.g., transmit processor 264, TX MIMO processor 266, modulator 254, and/or antennas 252) and the reception circuitry may include, for example, one or more components (e.g., receive processor 258, MIMO detector 256, demodulator 254, and/or antennas 252), as discussed above with respect to FIG. 2. In some aspects, the UE 120 may include the UE 120 discussed with respect to FIG. 2.

By utilizing the dynamic reconfiguration associated with transmitting SRS information, as discussed herein, a UE may utilize select SRS ports to transmit the SRS information including select SRS resources sufficient to enable the BS to estimate a measure of quality associated with uplink communications. In this way, the BS may adequately receive the uplink communications from the UE, and the data communication between the UE and the BS may continue uninterrupted. Additionally, transmitting the SRS information including the select SRS resources, sufficient for the BS to estimate the measure of quality associated with the uplink communications, may enable efficient utilization of UE resources (e.g., amount of processing, utilization of memory, or the like) and network resources (e.g., bandwidth, subchannels, or the like), and data communication between the UE and the BS may be improved.

As indicated above, FIGS. 3-5 are provided as examples. Other examples may differ from what is described with regard to FIGS. 3-5.

FIG. 6 is a diagram illustrating an example process 600 performed, for example, by a UE (e.g., UE 120), in accordance with various aspects of the present disclosure. Example process 600 is an example where the UE performs operations associated with dynamic reconfiguration associated with transmitting SRS information.

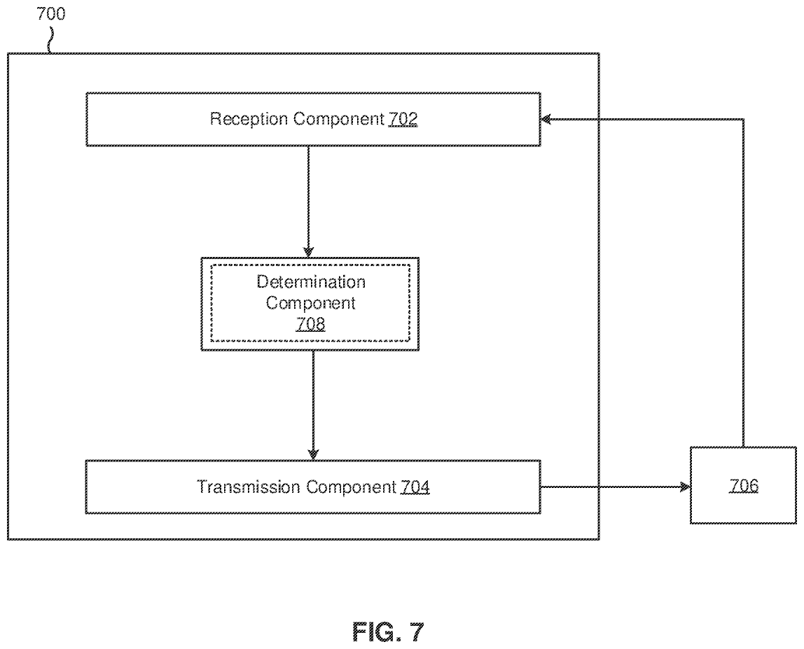

As shown in FIG. 6, in some aspects, process 600 may include receiving configuration information including an SRS configuration associated with configured SRS resources (block 610). For example, the UE (e.g., using reception component 702, depicted in FIG. 7) may receive configuration information including an SRS configuration associated with configured SRS resources, as described above.

As further shown in FIG. 6, in some aspects, process 600 may include receiving MAC CE or DCI including reconfiguration information associated with the SRS resources (block 620). For example, the UE (e.g., using reception component 702, depicted in FIG. 7) may receive a MAC CE or DCI including reconfiguration information associated with the SRS resources, as described above.

As further shown in FIG. 6, in some aspects, process 600 may include transmitting, based at least in part on the reconfiguration information, SRS information including select SRS resources, selected from among the configured SRS resources, utilizing select SRS ports (block 630). For example, the UE (e.g., using transmission component 704, depicted in FIG. 7) may transmit, based at least in part on the reconfiguration information, SRS information including select SRS resources, selected from among the configured SRS resources, utilizing select SRS ports, as described above.

Process 600 may include additional aspects, such as any single aspect or any combination of aspects described below and/or in connection with one or more other processes described elsewhere herein.

In a first aspect, a number of the select SRS resources is less than a total number of the configured SRS resources.

In a second aspect, alone or in combination with the first aspect, the configuration information includes SRS resource identifiers, an ordered list of the SRS resource identifiers, or a predefined pattern associated with the SRS resource identifiers.

In a third aspect, alone or in combination with one or more of the first and second aspects, the reconfiguration information indicates a quantity of the select SRS resources.

In a fourth aspect, alone or in combination with one or more of the first through third aspects, the reconfiguration information indicates SRS resource identifiers associated with the select SRS resources or a resource set identifier associated with a resource set including the select SRS resources.

In a fifth aspect, alone or in combination with one or more of the first through fourth aspects, the reconfiguration information indicates an updated order associated with the select SRS resources.

In a sixth aspect, alone or in combination with one or more of the first through fifth aspects, the reconfiguration information includes a codepoint associated with a combination of a number of the select SRS resources and SRS resource identifiers or an ordered list of the SRS resource identifiers.

In a seventh aspect, alone or in combination with one or more of the first through fifth aspects, the reconfiguration information includes a bitmap associated with a combination of a number of the select SRS resources and SRS resource identifiers or an ordered list of the SRS resource identifiers.

In an eighth aspect, alone or in combination with one or more of the first through seventh aspects, the MAC CE deactivates one or more SRS resources, from among the SRS resources, and the DCI indicates a number of the select SRS resources, from among a remainder of the SRS resources not deactivated by the MAC CE.

In a ninth aspect, alone or in combination with one or more of the first through eighth aspects, the DCI includes an SRS request indicator to indicate a number of the select SRS resources.

In a tenth aspect, alone or in combination with one or more of the first through ninth aspects, the DCI includes one or more bit fields to indicate a number of the select SRS resources or SRS resource identifiers associated with the select SRS resources.

In an eleventh aspect, alone or in combination with one or more of the first through tenth aspects, the reconfiguration information indicates a number of the select SRS ports.

In a twelfth aspect, alone or in combination with one or more of the first through eleventh aspects, the reconfiguration information indicates a number of the select SRS ports associated with one or more triggered SRS resource sets.

In a thirteenth aspect, alone or in combination with one or more of the first through twelfth aspects, the MAC CE deactivates an SRS resource from among the SRS resources and the DCI indicates a number of the select SRS ports associated with a remainder of the SRS resources not deactivated by the MAC CE.

In a fourteenth aspect, alone or in combination with one or more of the first through thirteenth aspects, transmitting the SRS information includes transmitting the SRS information based at least in part on a time of receipt associated with the MAC CE or a time of receipt associated with the DCI.

In a fifteenth aspect, alone or in combination with one or more of the first through fourteenth aspects, the select SRS resources and the select SRS ports are associated with a transmission-reception point, among a plurality of transmission-reception points in communication with the UE.

In a sixteenth aspect, alone or in combination with one or more of the first through fifteenth aspects, a number of selected SRS ports is associated with a transmission power related to transmitting the SRS information.

In a seventeenth aspect, alone or in combination with one or more of the first through sixteenth aspects, a transmission power is associated with the select SRS resources included in a given SRS resource set.

In an eighteenth aspect, alone or in combination with one or more of the first through seventeenth aspects, transmitting the SRS information includes transmitting the SRS information based at least in part on the reconfiguration information during a current transmission associated with transmitting the SRS information.

In a nineteenth aspect, alone or in combination with one or more of the first through eighteenth aspects, transmitting the SRS information includes transmitting the SRS information based at least in part on the reconfiguration information during a current transmission and a future transmission associated with transmitting the SRS information.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a block diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. The determination component 708 may analyze information included in the configuration information, the MAC CE, and/or the DCI and, based at least in part on the analysis, may determine the information to be included in the SRS information.

In some aspects, the apparatus 700 may be configured to perform one or more operations described herein in connection with FIGS. 3-5. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be co-located with the reception component 702 in a transceiver.

The reception component 702 may receive configuration information including an SRS configuration associated with configured SRS resources. The reception component 702 may receive a MAC CE or DCI including reconfiguration information associated with the SRS resources. The transmission component 704 may transmit, based at least in part on the reconfiguration information, SRS information including select SRS resources, selected from among the configured SRS resources, utilizing select SRS ports.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some aspects of the present disclosure:

Aspect 1: A method of wireless communication performed by a user equipment (UE), comprising: receiving configuration information including a sounding reference signal (SRS) configuration associated with configured SRS resources; receiving a medium access control (MAC) control element (MAC CE) or downlink control information (DCI) including reconfiguration information associated with the SRS resources, and transmitting, based at least in part on the reconfiguration information, SRS information including select SRS resources, selected from among the configured SRS resources, utilizing select SRS ports.

Aspect 2: The method of aspect 1, wherein a number of the select SRS resources is less than a total number of the configured SRS resources.

Aspect 3: The method of any of aspects 1-2, wherein the configuration information includes SRS resource identifiers, an ordered list of the SRS resource identifiers, or a predefined pattern associated with the SRS resource identifiers.

Aspect 4: The method of any of aspects 1-3, wherein the reconfiguration information indicates a quantity of the select SRS resources.

Aspect 5: The method of any of aspects 1-4, wherein the reconfiguration information indicates SRS resource identifiers associated with the select SRS resources or a resource set identifier associated with a resource set including the select SRS resources.

Aspect 6: The method of any of aspects 1-5, wherein the reconfiguration information indicates an updated order associated with the select SRS resources.

Aspect 7: The method of any of aspects 1-6, wherein the reconfiguration information includes a codepoint associated with a combination of a number of the select SRS resources and SRS resource identifiers or an ordered list of the SRS resource identifiers.

Aspect 8: The method of any of aspects 1-6, wherein the reconfiguration information includes a bitmap associated with a combination of a number of the select SRS resources and SRS resource identifiers or an ordered list of the SRS resource identifiers.

Aspect 9: The method of any of aspects 1-8, wherein the MAC CE deactivates one or more SRS resources, from among the SRS resources, and the DCI indicates a number of the select SRS resources, from among a remainder of the SRS resources not deactivated by the MAC CE.

Aspect 10: The method of any of aspects 1-9, wherein the DCI includes an SRS request indicator to indicate a number of the select SRS resources.

Aspect 11: The method of any of aspects 1-10, wherein the DCI includes one or more bit fields to indicate a number of the select SRS resources or SRS resource identifiers associated with the select SRS resources.

Aspect 12: The method of any of aspects 1-11, wherein the reconfiguration information indicates a number of the select SRS ports.

Aspect 13: The method of any of aspects 1-12, wherein the reconfiguration information indicates a number of the select SRS ports associated with one or more triggered SRS resource sets.

Aspect 14: The method of any of aspects 1-13, wherein the MAC CE deactivates an SRS resource from among the SRS resources and the DCI indicates a number of the select SRS ports associated with a remainder of the SRS resources not deactivated by the MAC CE.

Aspect 15: The method of any of aspects 1-14, wherein transmitting the SRS information includes transmitting the SRS information based at least in part on a time of receipt associated with the MAC CE or a time of receipt associated with the DCI.

Aspect 16: The method of any of aspects 1-15, wherein the select SRS resources and the select SRS ports are associated with a transmission-reception point, among a plurality of transmission-reception points in communication with the UE.

Aspect 17: The method of any of aspects 1-16, wherein a number of selected SRS ports is associated with a transmission power related to transmitting the SRS information.

Aspect 18: The method of any of aspects 1-17, wherein a transmission power is associated with the select SRS resources included in a given SRS resource set.

Aspect 19: The method of any of aspects 1-18, wherein transmitting the SRS information includes transmitting the SRS information based at least in part on the reconfiguration information during a current transmission associated with transmitting the SRS information.

Aspect 20: The method of any of aspects 1-19, wherein transmitting the SRS information includes transmitting the SRS information based at least in part on the reconfiguration information during a current transmission and a future transmission associated with transmitting the SRS information.

Aspect 21: An apparatus for wireless communication at a device, comprising a processor, memory coupled with the processor; and instructions stored in the memory and executable by the processor to cause the apparatus to perform the method of one or more aspects of aspects 1-20.

Aspect 22: A device for wireless communication, comprising a memory and one or more processors coupled to the memory, the memory and the one or more processors configured to perform the method of one or more aspects of aspects 1-20.

Aspect 23: An apparatus for wireless communication, comprising at least one means for performing the method of one or more aspects of aspects 1-20.

Aspect 24: A non-transitory computer-readable medium storing code for wireless communication, the code comprising instructions executable by a processor to perform the method of one or more aspects of aspects 1-20.

Aspect 25: A non-transitory computer-readable medium storing a set of instructions for wireless communication, the set of instructions comprising one or more instructions that, when executed by one or more processors of a device, cause the device to perform the method of one or more aspects of aspects 1-20.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors coupled to the one or more memories and configured to:
receive configuration information including a sounding reference signal (SRS) configuration associated with configured SRS resources;
receive a medium access control (MAC) control element (MAC CE) or downlink control information (DCI) including reconfiguration information associated with the SRS resources; and
transmit, based at least in part on the reconfiguration information, SRS information including select SRS resources, selected from among the configured SRS resources, utilizing select SRS ports.

2. The UE of claim 1, wherein the one or more processors are configured to dynamically receive the MAC CE or the DCI from a base station.

3. The UE of claim 1, wherein the configuration information includes SRS resource identifiers, an ordered list of the SRS resource identifiers, or a predefined pattern associated with the SRS resource identifiers.

4. The UE of claim 1, wherein the reconfiguration information indicates a quantity of the select SRS resources.

5. The UE of claim 1, wherein the reconfiguration information indicates SRS resource identifiers associated with the select SRS resources or a resource set identifier associated with a resource set including the select SRS resources.

6. The UE of claim 1, wherein the reconfiguration information indicates an updated order associated with the select SRS resources.

7. The UE of claim 1, wherein the reconfiguration information includes a codepoint associated with a combination of a number of the select SRS resources and SRS resource identifiers or an ordered list of the SRS resource identifiers.

8. The UE of claim 1, wherein the reconfiguration information includes a bitmap associated with a combination of a number of the select SRS resources and SRS resource identifiers or an ordered list of the SRS resource identifiers.

9-11. (canceled)

12. The UE of claim 1, wherein the reconfiguration information indicates a number of the select SRS ports.

13. The UE of claim 1, wherein the reconfiguration information indicates a number of the select SRS ports associated with one or more triggered SRS resource sets.

14. (canceled)

15. The UE of claim 1, wherein the one or more processors, when transmitting the SRS information, are configured to transmit the SRS information based at least in part on a time of receipt associated with the MAC CE or a time of receipt associated with the DCI.

16. The UE of claim 1, wherein the select SRS resources and the select SRS ports are associated with a transmission-reception point, among a plurality of transmission-reception points in communication with the UE.

17. The UE of claim 1, wherein a number of selected SRS ports is associated with a transmission power related to transmitting the SRS information.

18. The UE of claim 1, wherein a transmission power is associated with the select SRS resources included in a given SRS resource set.

19. The UE of claim 1, wherein the one or more processors, when transmitting the SRS information, are configured to transmit the SRS information based at least in part on the reconfiguration information during a current transmission associated with transmitting the SRS information.

20. The UE of claim 1, wherein the one or more processors, when transmitting the SRS information, are configured to transmit the SRS information based at least in part on the reconfiguration information during a current transmission and a future transmission associated with transmitting the SRS information.

21. A method of wireless communication performed by a user equipment (UE), comprising:
receiving configuration information including a sounding reference signal (SRS) configuration associated with configured SRS resources;
receiving a medium access control (MAC) control element (MAC CE) or downlink control information (DCI) including reconfiguration information associated with the SRS resources; and
transmitting, based at least in part on the reconfiguration information, SRS information including select SRS resources, selected from among the configured SRS resources, utilizing select SRS ports.

22. The method of claim 21, wherein a number of the select SRS resources is less than a total number of the configured SRS resources.

23. The method of claim 21, wherein the configuration information includes SRS resource identifiers, an ordered list of the SRS resource identifiers, or a predefined pattern associated with the SRS resource identifiers.

24. The method of claim 21, wherein the reconfiguration information indicates a quantity of the select SRS resources.

25. The method of claim 21, wherein the reconfiguration information indicates SRS resource identifiers associated with the select SRS resources or a resource set identifier associated with a resource set including the select SRS resources.

26. The method of claim 21, wherein the reconfiguration information indicates an updated order associated with the select SRS resources.

27. The method of claim 21, wherein the reconfiguration information includes a codepoint associated with a combination of a number of the select SRS resources and SRS resource identifiers or an ordered list of the SRS resource identifiers.

28. The method of claim 21, wherein the reconfiguration information includes a bitmap associated with a combination of a number of the select SRS resources and SRS resource identifiers or an ordered list of the SRS resource identifiers.

29-31. (canceled)

32. The method of claim 21, wherein the reconfiguration information indicates a number of the select SRS ports.

33. The method of claim 21, wherein the reconfiguration information indicates a number of the select SRS ports associated with one or more triggered SRS resource sets.

34. (canceled)

35. The method of claim 21, wherein transmitting the SRS information includes transmitting the SRS information based at least in part on a time of receipt associated with the MAC CE or a time of receipt associated with the DCI.

36-39. (canceled)

40. The method of claim 21, wherein transmitting the SRS information includes transmitting the SRS information based at least in part on the reconfiguration information during a current transmission and a future transmission associated with transmitting the SRS information.

41. A non-transitory computer-readable medium storing a set of instructions for wireless communication, the set of instructions comprising:
one or more instructions that, when executed by one or more processors of a user equipment (UE), cause the UE to:
receive configuration information including a sounding reference signal (SRS) configuration associated with configured SRS resources;
receive a medium access control (MAC) control element (MAC CE) or downlink control information (DCI) including reconfiguration information associated with the SRS resources; and
transmit, based at least in part on the reconfiguration information, SRS information including select SRS resources, selected from among the configured SRS resources, utilizing select SRS ports.

42. An apparatus for wireless communication, comprising:
means for receiving configuration information including a sounding reference signal (SRS) configuration associated with configured SRS resources;
means for receiving a medium access control (MAC) control element (MAC CE) or downlink control information (DCI) including reconfiguration information associated with the SRS resources; and
means for transmitting, based at least in part on the reconfiguration information, SRS information including select SRS resources, selected from among the configured SRS resources, utilizing select SRS ports.
